(19) United States
(12) Patent Application Publication
(10) Pub. No.: US 2011/0209473 A1
(43) Pub. Date: Sep. 1, 2011

(54) SYSTEM AND METHOD FOR WASTE HEAT RECOVERY IN EXHAUST GAS RECIRCULATION

(76) Inventors: Jassin Fritz, Muenchen (DE); Georgios Bikas, Freising (DE); Gabor Ast, Garching (DE); Alexander Simpson, Munich (DE); Thomas Johannes Frey, Regensburg (DE); Rodrigo Rodriguez Erdmenger, Munchen (DE)

(21) Appl. No.: 12/713,275

(22) Filed: Feb. 26, 2010

(51) Int. Cl. F02B 33/44; F01K 23/10; F01B 31/10

(52) U.S. Cl. 60/605.2; 60/618; 60/670; 60/657

(57) ABSTRACT

A system and method for waste heat recovery in exhaust gas recirculation is disclosed. The system includes an engine having an intake manifold and an exhaust manifold, an exhaust conduit connected to the exhaust manifold, and a turbocharger having a turbine and a compressor, the turbine being connected to the exhaust conduit to receive a portion of the exhaust gas from the exhaust manifold. The system also includes an EGR system connected to the exhaust conduit to receive a portion of the exhaust gas, with the EGR system including an EGR conduit that is connected to the exhaust conduit to receive a portion of the exhaust gas, a heat exchanger connected to the EGR conduit and being configured to extract heat from the exhaust gas, and a waste heat recovery system connected to the heat exchanger and configured to capture the heat extracted by the heat exchanger.

### BACKGROUND OF THE INVENTION

Embodiments of the invention relate generally to engine exhaust emission reduction systems and, more particularly, to a system and method for waste heat recovery in exhaust gas recirculation.

Production of emissions from mobile and stationary combustion sources such as locomotives, vehicles, power plants, and the like, contribute to environmental pollution. One particular source of such emissions are nitric oxides (NOₓ), such as NO or NO₂, emissions from vehicles, locomotives, generators, and the like. Environmental legislation restricts the amount of NOₓ that can be emitted by vehicles. In order to comply with this legislation, exhaust gas recirculation (EGR) systems have been implemented to reduce the amount of NOₓ emissions. However, existing EGR systems are limited in their design and efficiency for operation of the combustion sources under various operating conditions.

Typically, EGR systems are arranged such that a desired quantity of exhaust gas is directed into a recirculation path, cooled with a heat exchanger, and recirculated into the engine by way of a compressor or other means such as turbocompounding, venturi, or a donor cylinder. The heat exchanger in the EGR system is required to cool the exhaust gas by a specified amount before the exhaust gas can be recirculated into the engine. Given the high rates of exhaust gas recirculation required to meet the emission regulations, the amount of heat or thermal energy rejected by the heat exchanger can be significant. For example, typically around 25-35% of the overall fuel energy, in the form of heat or thermal energy, is still in the exhaust gas after combustion of the fuel. For an EGR system where 30% of the exhaust gas is recirculated, this amount can be more than 10% of the fuel energy (present in the form of heat/thermal energy in the exhaust gas) that flows through the EGR system being rejected by the heat exchanger.

Typically this thermal energy that is rejected by the heat exchanger is simply vented to the ambient environment, thus wasting the thermal energy in the exhaust gas that could potentially be used for further power generation to increase an overall engine efficiency. Accordingly, this rejection of thermal energy results in an overall decreased efficiency of the engine system.

As such, would be desirable to provide a system and method for utilizing the thermal energy present in the exhaust gas before recirculating the exhaust gas into the intake manifold. The usage of a portion of the thermal energy present in the exhaust gas, which otherwise would be rejected to the ambient, would lead to an increase of the overall engine efficiency.

### BRIEF DESCRIPTION OF THE INVENTION

Embodiments of the invention are directed to a system and method for waste heat recovery in exhaust gas recirculation.

In accordance with one aspect of the invention, an engine system includes an engine having an intake manifold and an exhaust manifold, an exhaust conduit connected to the exhaust manifold to convey an exhaust gas away from the engine, and a turbocharger having a turbine and a compressor driven by the turbine, wherein the turbine is connected to the exhaust conduit to receive a portion of the exhaust gas from the exhaust manifold, and wherein the compressor is positioned upstream of, and connected to, the intake manifold. The engine system also includes an exhaust gas recirculation (EGR) system connected to the exhaust conduit to receive at least a portion of the exhaust gas therefrom, with the EGR system further including an EGR conduit connected to the exhaust conduit to receive the at least a portion of the exhaust gas and having an input and an output, a heat exchanger connected to the EGR conduit between the input and the output and being configured to extract heat from the at least a portion of the exhaust gas, and a waste heat recovery system connected to the heat exchanger and configured to capture the heat extracted by the heat exchanger.

In accordance with another aspect of the invention, an exhaust gas recirculation (EGR) apparatus includes an EGR circuit having an input configured to receive an exhaust gas from an engine exhaust port, an output configured to return the exhaust gas to an intake port of the engine, and an EGR path configured to circulate the exhaust gas between the input and the output. The EGR apparatus also includes a heat exchanger connected to the EGR circuit in the EGR path between the input and the output and configured to extract thermal energy from the exhaust gas circulating through the EGR path and a waste heat recovery apparatus connected to the heat exchanger and configured to capture the thermal energy extracted by the heat exchanger.

In accordance with yet another aspect of the invention, a method for capturing waste heat in an engine system includes conveying exhaust gas from an exhaust manifold of an internal combustion engine to an exhaust gas recirculation (EGR) system and circulating the exhaust gas through an EGR conduit of the EGR system. The method also includes extracting heat from the exhaust gas circulating through the EGR conduit by way of a heat exchanger and capturing the heat extracted by the heat exchanger in a waste heat recovery system.

Various other features and advantages will be made apparent from the following detailed description and the drawings.

### BRIEF DESCRIPTION OF THE DRAWINGS

The drawings illustrate preferred embodiments presently contemplated for carrying out the invention.

In the drawings:

FIG. 1 is a schematic diagram of an internal combustion engine system incorporating an exhaust gas recirculation (EGR) system and waste heat recovery system according to an embodiment of the invention.

FIG. 2 is another schematic diagram of an internal combustion engine system incorporating an EGR system and waste heat recovery system according to an embodiment of the invention.

FIG. 3 is another schematic diagram of an internal combustion engine system incorporating an EGR system and waste heat recovery system according to an embodiment of the invention.

FIG. 4 is another schematic diagram of an internal combustion engine system incorporating an EGR system and waste heat recovery system according to an embodiment of the invention.

FIG. 5 is another schematic diagram of an internal combustion engine system incorporating an EGR system and waste heat recovery system according to an embodiment of the invention.

FIG. 6 is another schematic diagram of an internal combustion engine system incorporating an EGR system and waste heat recovery system according to an embodiment of the invention.

### DETAILED DESCRIPTION

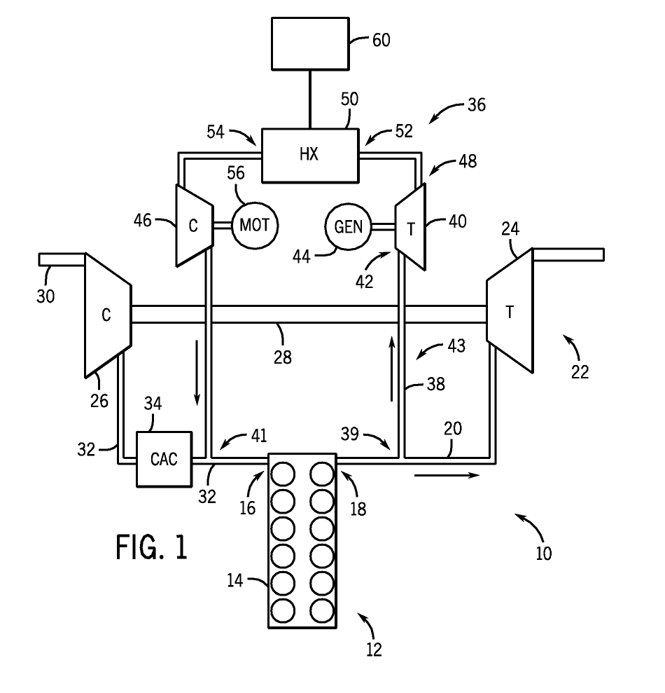

Referring to FIG. 1, a schematic illustration of an internal combustion engine system generally designated 10 is illustrated. The internal combustion engine system includes both mobile applications (e.g., automobiles, locomotives) and stationary applications (e.g., power plants). For ease in discussion, the internal combustion engine system 10 is discussed hereinafter in relation to a compression ignition engine system with the understanding that the discussion can readily be applied to other systems (e.g., systems that employ both spark ignition and compression ignition).

The internal combustion engine system 10 comprises an engine 12, which includes an engine body 14, an air intake manifold 16, and an exhaust manifold 18. The air intake manifold 16 serves to deliver intake air (e.g., an oxygen-containing gas) to combustion chambers (e.g., cylinders) in the engine body 14 via intake valves (not shown). That is, the intake manifold 16 is connected with the combustion chambers to deliver intake air thereto. During operation, a fuel from a fuel source (not shown) is introduced into the combustion chambers. The type of fuel varies depending on the application. However, suitable fuels include hydrocarbon fuels such as gasoline, diesel, ethanol, methanol, kerosene, jet fuel, and the like; gaseous fuels, such as natural gas, methane, propane, butane, and the like; and alternative fuels, such as hydrogen, biofuels, dimethyl ether, synthetic fuels, and the like; as well as combinations comprising at least one of the foregoing fuels. The fuel is then combusted with the oxygen-containing gas to generate power.

The exhaust manifold 18 of the engine 12 is connected with the combustion chambers and serves to collect the exhaust gases generated by the engine 12. The exhaust manifold 18 is also connected with an exhaust conduit 20, which is further connected with a turbocharger 22. The turbocharger 22 includes therein a turbine 24 and a compressor 26, such as a centrifugal compressor. In one embodiment, a turbine wheel of the turbine 24 is coupled to compressor 26 by way of a drive shaft 28. During operation, the exhaust gases from exhaust conduit pass through the turbine 24 and cause the turbine wheel to spin, which causes the drive shaft 28 to turn, thereby causing the compressor wheel of the compressor 26 to spin. The centrifugal compressor 26 draws in air at the center of the compressor wheel and moves the air outward as the compressor wheel spins. Ambient air enters the compressor 26 through an intake 30, and compressor 26 works to compress the air so as to provide an increased mass of air to the intake manifold 16 of engine 12. The compressed air from compressor 26 is supplied to an intake air conduit 32 to transfer the fresh air to the intake manifold 16, which in turn supplies the combustion chambers of engine 12. Connected to intake air conduit 32 downstream of compressor 26 and upstream from intake manifold 16 is a charge air cooler 34. Charge air cooler 34 cools the fresh/ambient air after exiting the compressor 26 of turbocharger 22 before it enters intake manifold 16. Meanwhile, the exhaust gas supplied to the turbine 24 is discharged to the atmosphere.

Also included in internal combustion engine system 10 is an exhaust gas recirculation (EGR) system 36. The EGR system 36 is connected to exhaust conduit 20 and receives a portion of the exhaust gases generated by engine 12 to be passively routed for introduction into the intake air conduit 32 to intake manifold 16. As shown in FIG. 1, according to an embodiment of the invention, an EGR conduit 38 branches off of exhaust conduit 20 at a location downstream of the exhaust manifold 18 and upstream of the turbine 24 of turbocharger 22. An input 39 of EGR conduit 38 receives exhaust gas from exhaust conduit 20. The exhaust gas is received at input 39 and circulated through the EGR system 36 by the EGR conduit 38, which forms an exhaust path by which to transfer the gas to an outlet 41 of EGR conduit 38 and out therefrom into the intake air conduit 32 for return to the intake manifold 16 of the engine 12, thus forming an EGR circuit 43.

According to an exemplary embodiment of the invention, a portion of the exhaust gas enters into EGR system 36 through inlet 39 and is directed through EGR conduit 38 to an expansion turbine 40 (i.e., expander), which receives the exhaust gas through an inlet 42 connected to EGR conduit 38. The exhaust gas received by expansion turbine 40 is at an elevated temperature, as it is received directly from exhaust manifold 18 of engine 12, and the expansion turbine 40 works to expand the exhaust gas to decrease the temperature thereof. The expansion of the exhaust gas produces work that is turned into power by the expansion turbine 40 in the form of a mechanical power output. As shown in FIG. 1, according to one embodiment of the invention, the mechanical power output generated by expansion turbine 40 is transferred to a generator 44 that is connected thereto, such that the generator will generate electrical power. The electrical power from generator 44 can be used to power various components in the internal combustion engine system 10, including an EGR compressor 46 positioned downstream from the expansion turbine 40 (by way of an electric motor), as will be explained in greater detail below. The amount of power generated by expansion turbine and transferred to generator 44 will vary according to the specific configuration of internal combustion engine system 10, but can be used to compensate for the power requirements of the motor.

Referring still to FIG. 1, after the exhaust gas is expanded and cooled by expansion turbine 40, it exits an outlet 48 of the expansion turbine and is transferred by way of EGR conduit 38 to a heat exchanger 50. The heat exchanger 50 has an inlet end 52 that is in fluid communication with the exhaust manifold 18. The heat exchanger 50 further cools the exhaust gas that is passed from the exhaust manifold 18 of the engine 12 and through the expansion turbine 40. Cooling of the “hot” exhaust gas is accomplished by the heat exchanger 50 using techniques that are well known in the art.

Upon further cooling by heat exchanger 50, the “cooled” exhaust gas exits the heat exchanger 50 at an outlet end 54 and is transferred to the EGR compressor 46 by EGR conduit 38. EGR compressor 46 functions to compress the exhaust gas to an acceptable level for transfer to the intake manifold 16 according to a forced air induction intake method. As the exhaust gas was expanded upon passage through the expansion turbine 40, the pressure of the exhaust gas requires compression work to be introduced into the intake manifold 16. Thus, EGR compressor 46 is configured to compress the exhaust gas. According to the embodiment of FIG. 1, power generated by expansion turbine 40 is used to drive the EGR compressor 46 to achieve such an increased pressure ratio. That is, power from the generator 44 is transferred to an electric motor 56, which operates at variable speeds/power outputs to supply a controlled power to the EGR compressor 46. The power provided from expansion turbine 40 is sufficient to allow for operation of the EGR compressor 46 within a large range of operating conditions. Beneficially, as the expansion turbine 40 operates independently (i.e., is decoupled) from the EGR compressor 46, the power output of expansion turbine 40 is not directly transmitted to the EGR compressor 46. Instead, the generator 44 and electric motor 56 provide for variable operation of the EGR compressor 46 independent from the expansion turbine 40, allowing the EGR compressor to operate with an increased degree of versatility and operate to produce a varied compression ratio as needed/desired by the internal combustion engine system 10.

Once the exhaust gas is compressed a target amount by the EGR compressor 46, the exhaust gas exits the EGR compressor via EGR conduit 38. As shown in FIG. 1, EGR conduit 38 joins with the intake air conduit 32 downstream of charged air cooler 34 to mix exhaust gas with ambient air such that the resulting mixture temperature can be below the temperature after the EGR compressor 46. Also an additional cooler (not shown) can be introduced downstream of the compressor 46. Thus, the exhaust gas circulated through EGR system 36 is mixed with fresh intake air provided from the turbocharger 22, and the mixture is transferred to intake manifold 16.

With respect to the embodiment of EGR system 36 shown in FIG. 1, it is recognized that EGR conduit 38 could join with the intake air conduit 32 upstream of the charged air cooler 34. Additionally, while EGR system 36 is shown above as including expansion turbine 40 and EGR compressor 46 (along with generator 44 and electric motor 56), it is recognized that EGR system 36 could be configured without such components. Additionally, EGR system 36 may be configured to include donor cylinders, turbocompounding, or backpressure valves.

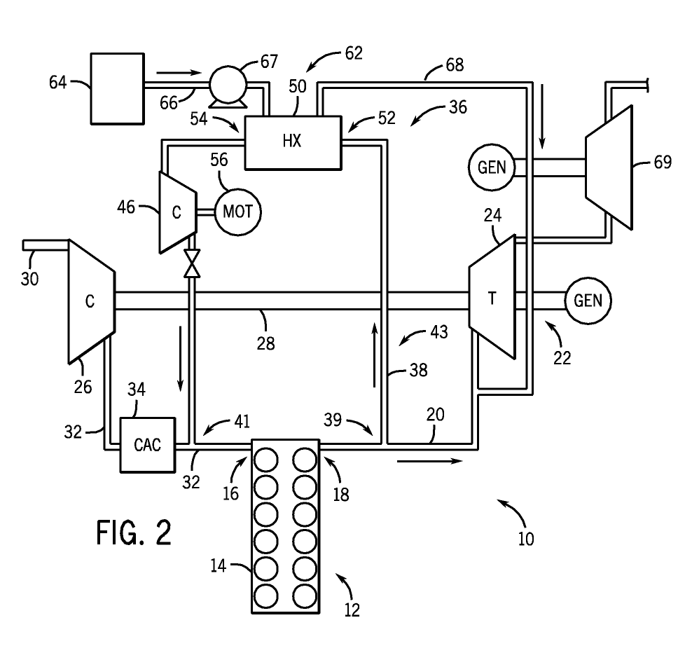

As further shown in FIG. 1, EGR system 36 of engine system 10 also includes a waste heat recovery system or apparatus, generally designated as 60, that is included to capture heat rejected by heat exchanger 50. That is, waste heat recovery system 60 is connected to heat exchanger 50 and works in conjunction therewith to “recover” heat extracted from the exhaust gas and transform this heat into usable energy. That is, in a typical EGR system, heat extracted from the exhaust gas, such as by a heat exchanger for example, is vented to the ambient environment, and thus a potential source of energy is wasted. According to embodiments of the invention, waste heat recovery system 60 makes use of the thermal energy or heat extracted from the exhaust gas by heat exchanger 50, by converting this thermal energy to mechanical energy. Specific embodiment of waste heat recovery system 60 are shown and described in detail below with respect to FIGS. 2-6.

Referring now to FIG. 2, according to an embodiment of the invention, a waste heat recovery system 62 is provided that is configured to generate steam for use with turbine 24 of turbocharger 22 and/or an additional turbine 69 for turbocompounding. Waste heat recovery system 62 is formed as an “open system” and includes a water supply 64 that supplies water to heat exchanger 50 in EGR system 36. According to one embodiment of the invention, water supply 64 may be a water source drawn from the environment, such as water taken in from a body of water in which engine system 10 is being operated (e.g., lake water, sea water) that provides a steady supply of water to heat exchanger 50, although it is also recognized that water supply 64 could be in the form of a water tank.

Also included in waste heat recovery system 62 is a water path 66 that connects water supply 64 to heat exchanger 50 and a pump 67 positioned along water path 66 to provide a flow of water to heat exchanger 50. The water flow provided to heat exchanger 50 is heated by the heat exchanger in a controllable manner such that steam is generated therefrom. That is, the thermal energy extracted from exhaust gas by heat exchanger 50 is used to heat the flow of water from water supply 64 to generate steam. A steam path 68 is connected to heat exchanger 50 to receive the steam generated from water supply 64 and routes the steam away from the heat exchanger 50. As shown in the embodiment of FIG. 2, steam path 68 is routed so as to introduce the steam into exhaust conduit 20 upstream of turbine 24. The steam is expanded in turbine 24 to generate mechanical power. Thus, thermal energy extracted from exhaust gas by heat exchanger 50 is utilized by waste heat recovery system 62 for generating mechanical power in turbine 24. This mechanical power can be transferred to a generator connected to the shaft of the turbocharger to transform the mechanical power into electric power or, alternatively, can be transferred to a gearbox (not shown) to transmit additional power to the shaft of the engine.

Referring still to FIG. 2, according to an embodiment of the invention, the steam introduced into exhaust conduit 20 upstream of turbine 24 by steam path 68 is additionally used to generate power in additional turbine 69 positioned downstream of turbine 24 on exhaust path 20 to provide turbocompounding. Thus, thermal energy extracted from exhaust gas by heat exchanger 50 is utilized by waste heat recovery system 62 to generate still additional mechanical power by way of additional turbine 69, thereby further improving the efficiency of engine system 10. While turbine 69 is shown as being positioned to receive steam and exhaust gas that exits turbine 24, it is also recognized that an arrangement of engine system 10 could be provided without turbine 69, such that the steam and exhaust gas that exits turbine 24 is vented to the ambient environment.

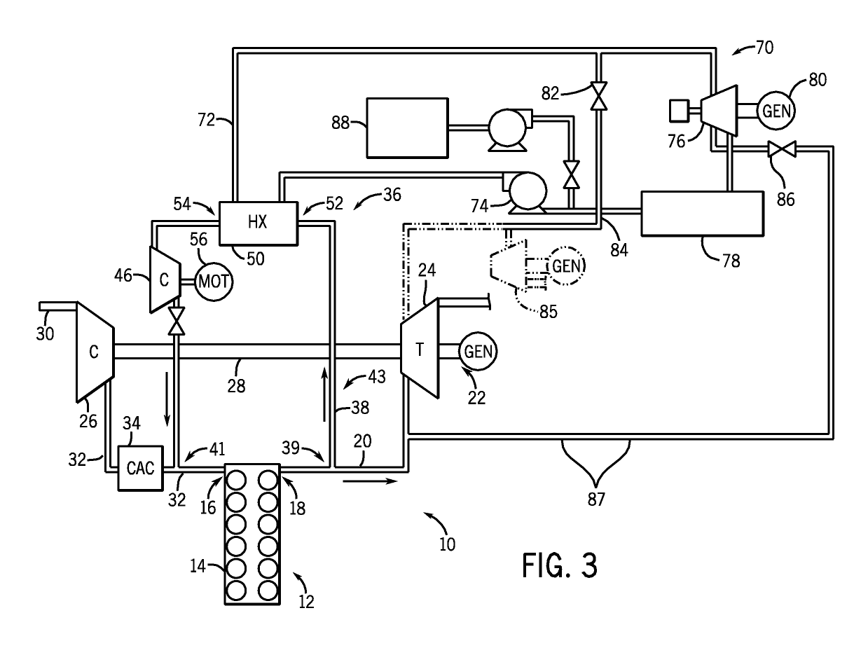

Referring now to FIG. 3, a waste heat recovery system 70 is provided that is configured as a Rankine cycle arrangement that utilizes heat exchanger 50 as a heat source for generating mechanical power. Rankine cycle arrangement 70 includes a closed loop fluid path 72 having a fluid pump 74, an expander 76, and a condenser 78 positioned therealong. A quantity of fluid is circulated through closed loop fluid path 72 by way of pump 74. According to one embodiment, fluid can be in the form of water. Alternatively, it is recognized that the fluid could be in the form of a refrigerant or an organic fluid having a boiling point lower or higher than water, such that the Rankine cycle arrangement 70 is in the form of an Organic Rankine cycle.

As shown in FIG. 3, pump 74 is positioned upstream of heat exchanger 50 in the closed loop fluid path 72 such that a stream of fluid is provided to the heat exchanger. Heat exchanger 50 of EGR system 36 extracts thermal energy from exhaust gas circulating through EGR conduit 38 and functions as a heat source for Rankine cycle arrangement 70. Heat exchanger 50 thus heats fluid circulating therethrough to form a vapor. Vapor exits heat exchanger 50 and is passed along closed loop fluid path 72 to expander 76, which is positioned downstream from the heat exchanger 50. Expander 76 functions to expand the vapor, thereby generating mechanical energy that is transferred, for example, to a generator 80 (or a crankshaft) to make use of the mechanical energy. Upon passing through expander 76, vapor passes to condenser 78 positioned downstream from the expander 76 in the closed loop fluid path 72 such that the vapor is cooled by the condenser 78. The condenser 78 cools the expanded vapor in a controlled manner to transform the vapor back into a liquid fluid, which can then be recirculated within Rankine cycle arrangement 70.

According to one embodiment of the invention, the Rankine cycle arrangement 70 includes a valve 82 positioned in the closed loop fluid path 72 between the heat exchanger 50 and the condenser 78 to allow for controlled venting of vapor from the closed loop fluid path 72 to a separate vapor path 84. For example, a valve 82 can be positioned in closed loop fluid path 72 upstream of expander 76 to vent a controlled amount of vapor into vapor path 84. Alternatively, or in addition to valve 82, a valve 86 can be positioned downstream of expander 76 (and upstream of condenser 78) to vent a controlled amount of vapor into a vapor path 87. The vapor diverted into vapor path(s) 84, 87 by valve(s) 82, 86 can be routed by the vapor path(s) 84, 87 into exhaust conduit 20 upstream of turbine 24 or can be routed directly to turbine 24, where the steam is expanded in turbine 24 to generate mechanical power. As shown in FIG. 3, according to an embodiment of the invention, vapor path 84 can be arranged to vent vapor to turbine 24. Alternatively, vapor path 84 can be arranged to vent vapor directly to a turbine 85, without vapor path 84 being connected to turbine 24.

Beneficially, valve(s) 82, 86 can thus provide for diversion of vapor from closed loop fluid path 72 such that a size of condenser 78 of Rankine cycle arrangement 70 can be reduced as compared to an arrangement where venting of vapor from closed loop fluid path 72 is not provided for. That is, upon condenser 78 reaching a peak load during operation of Rankine cycle arrangement 70, valve(s) 82, 86 can be actuated to remove vapor from closed loop fluid path 72, thereby eliminating the need for increased cooling by condenser 78.

As vapor is selectively vented from the closed loop fluid path 72 by valve(s) 82, 86, an additional fluid supply 88 is connected to Rankine cycle arrangement 70 to provide additional fluid thereto, thereby replacing fluid that was removed from the closed loop fluid path 72 in the form of vapor diverted into vapor path 84. While valve(s) 82, 86 and fluid supply 88 are shown as being included in Rankine cycle arrangement 70 that allow for venting of vapor from the fluid path 72, thus forming a “partially open” system, it is also recognized that a Rankine cycle arrangement 70 could be provided without valve(s) 82, 86 and fluid supply 88, thus providing a closed system where a constant amount of fluid/vapor is contained within closed loop fluid path 72.

As shown in FIG. 3, the Rankine cycle arrangement 70 provides for generation of mechanical power via more than one expander or turbine. That is, in addition to generating mechanical power by way of expander 76, diversion of steam from closed loop fluid path 72 also allows for thermal energy extracted from exhaust gas by heat exchanger 50 to be utilized by waste heat recovery system 70 for generating mechanical power in one or more turbines 24, 85 when desired, such as when the condenser 78 reaches a peak load.

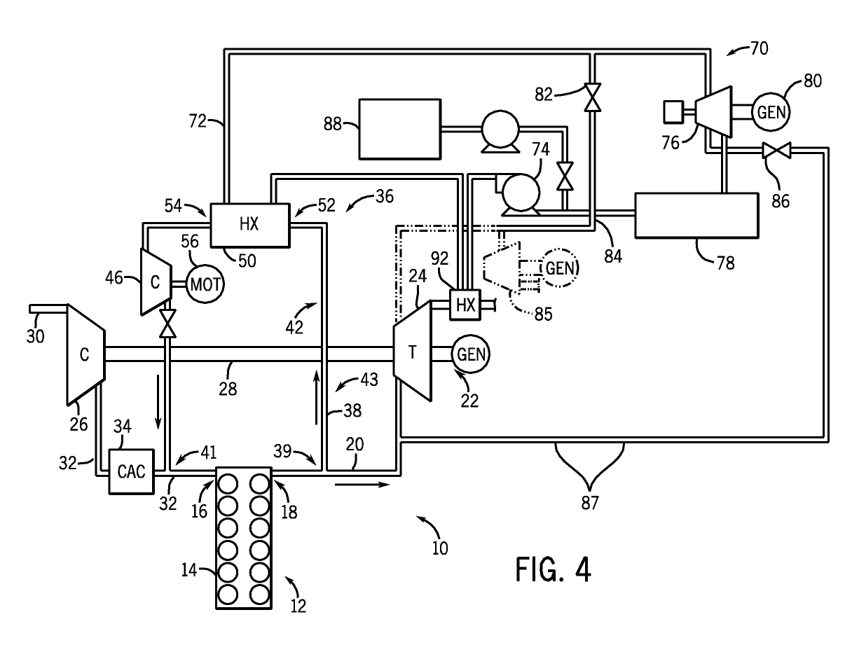

Referring now to FIG. 4, according to another embodiment of the invention, a second heat exchanger 92 is provided in engine system 10 and is positioned on exhaust conduit 20 downstream of turbine 24 to recover waste heat from the exhaust gas passing therethrough. Heat exchanger 92 extracts thermal energy from exhaust gas output from turbine 24 and functions as an additional heat source for Rankine cycle arrangement 70 (in conjunction with heat exchanger 50), and is thus connected to closed loop fluid path 72. As shown in FIG. 4, pump 74 is positioned upstream of heat exchanger 92 in the closed loop fluid path 72 such that a stream of fluid is provided to the heat exchanger 92. Fluid passes through heat exchanger 92 and downstream along fluid path 72 to heat exchanger 50, with the pair of heat exchangers 92, 50 heating the fluid circulating through fluid path 72 so as to form a vapor. The vapor then exits heat exchanger 50 and is passed along closed loop fluid path 72 to expander 76, which functions to expand the vapor to generate mechanical and/or electrical energy, with the expanded vapor then passing to condenser 78 such that the vapor is cooled by the condenser 78 to reform a liquid fluid.

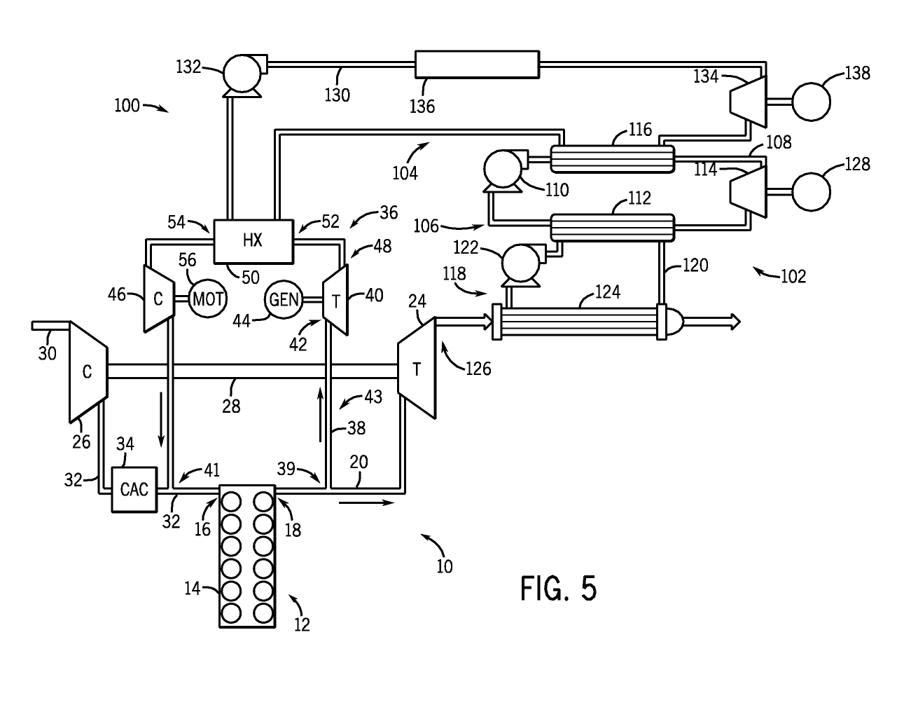

Referring now to FIG. 5, according to an embodiment of the invention, engine system 10 includes first and second waste heat recovery systems 100, 102 for capturing energy from exhaust gas circulating through EGR system 36, as well as exhaust gas circulating through exhaust conduit 20. The first and second waste heat recovery systems 100, 102 form a cascading Rankine cycle arrangement that includes what are generally designated as a “low temperature loop” Rankine cycle arrangement and a “high temperature loop” Rankine cycle arrangement. According to an embodiment of the invention, the first waste heat recovery system 100 functions as the “high temperature loop” Rankine cycle arrangement 104 and the second waste heat recovery system 102 functions as the “low temperature loop” Rankine cycle arrangement 106. The low temperature loop 106 of the cascading Rankine cycle arrangement is thus connected to exhaust conduit 20 downstream of turbine 24 to recover waste heat from the exhaust gas passing therethrough, while the high temperature loop 104 of the cascading Rankine cycle arrangement is included in EGR system 36 to recover waste heat from the exhaust gas circulating therethrough.

As shown in FIG. 5, the second waste heat recovery system 102 includes a Rankine cycle arrangement that forms the low temperature loop 106 of the cascading Rankine cycle arrangement. The low temperature loop Rankine cycle arrangement 106 includes a closed loop fluid path 108 having a fluid pump 110, an expander 114, and a condenser 116 positioned therealong. A quantity of fluid is circulated through closed loop fluid path 108 by way of pump 110. According to one embodiment, fluid can be in the form of water. Alternatively, it is recognized that fluid could be in the form of a refrigerant or an organic fluid having a boiling point lower or higher than water, such that the low temperature loop Rankine cycle arrangement 106 is in the form of an Organic Rankine cycle.

Separate from low temperature loop Rankine cycle arrangement 106, second waste heat recovery system 102 also includes a separate thermal oil loop 118 that operates in conjunction therewith. Thermal oil loop 118 includes a closed loop fluid path 120, a pump 122 to circulate oil therethrough, and an evaporator 112. As shown in FIG. 5, thermal oil loop 118 is connected to a heat exchanger 124 positioned at an output 126 of turbine 24 and that receives exhaust gas that is passed thereto from engine system 10 via exhaust conduit 20. Exhaust gas output from turbine 24 is received by heat exchanger 124, which extracts thermal energy from the exhaust gas. The thermal energy extracted from the exhaust gas by heat exchanger 124 is transferred to oil being circulated through closed loop fluid path 120 by way of pump 122.

The heated oil circulating through thermal oil loop 118 acts as a heat source for the low temperature loop Rankine cycle arrangement 106. That is, in operation, pump 132 of the low temperature loop 106 pumps a stream of fluid to evaporator 112. Evaporator 112 transfers thermal energy from the heated oil circulating through thermal oil loop 118 to the fluid circulating through closed loop fluid path 108, thereby functioning as a heat source for the low temperature loop Rankine cycle arrangement 106. Evaporator 112 heats fluid circulating through closed loop fluid path 108 to form a vapor in the closed loop fluid path 108. Vapor exits evaporator 112 and is passed along closed loop fluid path 108 to expander 114 positioned downstream from the evaporator 112. Expander 114 functions to expand the vapor, thereby generating mechanical energy that is transferred, for example, to a generator 128 (or a crankshaft) to make use of the mechanical energy. Upon passing through expander 114, vapor passes to condenser 116 positioned downstream from the expander 114 in the closed loop fluid path 108 such that the vapor is cooled by the condenser 116. The condenser 116 cools the expanded vapor in a controlled manner to transform the vapor back into a liquid fluid, which is then received by pump 110 and recirculated through the closed loop fluid path 108.

As further shown in FIG. 5, the first waste heat recovery system 100 is configured as a Rankine cycle arrangement that forms the high temperature loop 104 of the cascading Rankine cycle arrangement. The high temperature loop Rankine cycle arrangement 104 is positioned in the EGR system 36 to recover waste heat from the exhaust gas circulating therethrough, using heat exchanger 50 as a heat source for generating mechanical power. The high temperature loop Rankine cycle arrangement 104 includes a closed loop fluid path 130 having a fluid pump 132, an expander 134, and a condenser 136 positioned therealong. A quantity of fluid is circulated through closed loop fluid path 130 by way of pump 132. According to one embodiment, fluid can be in the form of water. Alternatively, it is recognized that fluid could be in the form of an a refrigerant or an organic fluid having a boiling point lower or higher than water such that the high temperature loop Rankine cycle arrangement 104 is in the form of an Organic Rankine cycle.

As shown in FIG. 5, pump 132 is positioned upstream of heat exchanger 50 in the closed loop fluid path 130 such that a stream of fluid is provided to heat exchanger 50. Heat exchanger 50 of EGR system 36 extracts thermal energy from exhaust gas circulating through EGR conduit 38 and functions as a heat source for high temperature loop Rankine cycle arrangement 104. Heat exchanger 50 thus heats fluid circulating therethrough, with either a heated fluid, a 2-phase mixture, or a vapor exiting the heat exchanger and being passed along closed loop fluid path 130 for further heating. That is, as shown in FIG. 5, the condenser 116 of the low temperature loop Rankine cycle arrangement 106 acts as an evaporator in the high temperature loop Rankine cycle arrangement 104. Thus, the heated fluid or a vapor passed from heat exchanger 50 and through closed loop fluid path 130 is further heated by condenser/evaporator 116 to form vapor. The vapor generated by condenser/evaporator 116 is passed to expander 134, which is positioned downstream therefrom in the closed loop fluid path 130. Expander 134 functions to expand the vapor, thereby generating mechanical energy that is transferred, for example, to a generator 138 (or a crankshaft) to make use of the mechanical energy. Upon passing through expander 134, vapor passes to a condenser 136 positioned downstream from the expander in the closed loop fluid path 130 such that the vapor is cooled by the condenser 136. The condenser 136 cools the expanded vapor in a controlled manner to transform the vapor back into a liquid fluid, which is then received by pump 132 and recirculated through the closed loop fluid path 130.

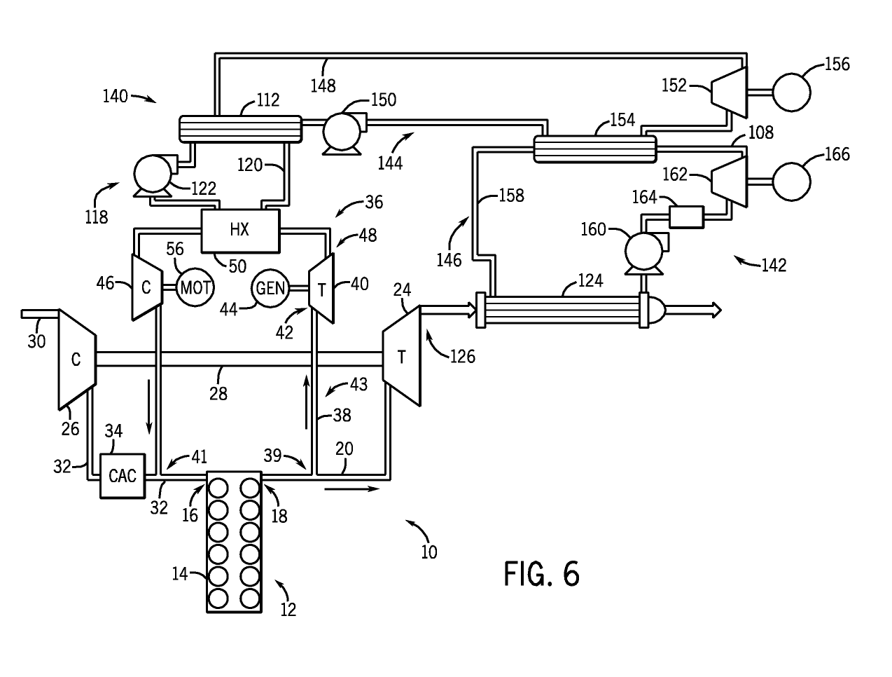

Referring now to FIG. 6, an engine system 10 incorporating first and second waste heat recovery systems 140, 142 is shown according to another embodiment of the invention. In the embodiment of engine system 10 shown in FIG. 6, the first waste heat recovery system 140 functions as a “high temperature loop” Rankine cycle arrangement 144 and the second waste heat recovery system 142 functions as a “low temperature loop” Rankine cycle arrangement 146. The high temperature loop 144 of the cascading Rankine cycle arrangement is connected to EGR conduit 38 to recover waste heat from the exhaust gas circulating through EGR system 36, while the low temperature loop 146 of the cascading Rankine cycle arrangement is connected to exhaust conduit 20 downstream of turbine 24 to recover waste heat from the exhaust gas passing therethrough.

As shown in FIG. 6, first waste heat recovery system 140 is configured as a Rankine cycle arrangement that forms the high temperature loop 144 of the cascading Rankine cycle arrangement. The high temperature loop Rankine cycle arrangement 144 is connected to the EGR system 36 to recover waste heat from the exhaust gas circulating therethrough, using heat exchanger 50 as a heat source for generating mechanical and/or electrical power. The high temperature loop Rankine cycle arrangement 144 includes a closed loop fluid path 148 having a fluid pump 150, an expander 152, and a condenser 154 positioned therealong. A quantity of fluid is circulated through closed loop fluid path 148 by way of pump 150. According to one embodiment, fluid can be in the form of water. Alternatively, it is recognized that fluid could be in the form of an a refrigerant or an organic fluid having a boiling point lower or higher than water such that the high temperature loop Rankine cycle arrangement 140 is in the form of an Organic Rankine cycle.

Separate from high temperature loop Rankine cycle arrangement 144, first waste heat recovery system 140 also includes a separate thermal oil loop 118 that operates in conjunction therewith. Thermal oil loop 118 includes a closed loop fluid path 120, a pump 122 to circulate oil therethrough, and an evaporator 112. As shown in FIG. 6, thermal oil loop 118 is connected to heat exchanger 50, which extracts thermal energy from the exhaust gas circulating through EGR system 36. The thermal energy extracted from the exhaust gas by heat exchanger 50 is transferred to oil being circulated through closed loop fluid path 120 by way of pump 122.

The heated oil circulating through thermal oil loop 118 acts as a heat source for the high temperature loop Rankine cycle arrangement 144. That is, in operation, pump 132 of the high temperature loop 144 pumps a stream of fluid to evaporator 112. Evaporator 112 transfers thermal energy from the heated oil circulating through thermal oil loop 118 to the fluid circulating through closed loop fluid path 148, thereby functioning as a heat source for the high temperature loop Rankine cycle arrangement 144. Evaporator 112 thus heats fluid circulating through closed loop fluid path 148 to form a vapor in the closed loop fluid path 148. Vapor exits evaporator 112 and is passed along closed loop fluid path 148 to expander 152 positioned downstream from the evaporator 112. Expander 152 functions to expand the vapor, thereby generating mechanical energy that is transferred, for example, to a generator 156 (or a crankshaft) to make use of the mechanical energy. Upon passing through expander 152, vapor passes to condenser 154 positioned downstream from the expander 152 in the closed loop fluid path 148 such that the vapor is cooled by the condenser 154. The condenser 154 cools the expanded vapor in a controlled manner to transform the vapor back into a liquid fluid, which is then received by pump 150 and recirculated through the closed loop fluid path 148.

As further shown in FIG. 6, the second waste heat recovery system 142 includes a Rankine cycle arrangement that forms the low temperature loop 146 of the cascading Rankine cycle arrangement. The low temperature loop Rankine cycle arrangement 146 is connected to heat exchanger 124 to recover waste heat from an output 126 of turbine 24, and thus uses heat exchanger 124 as a heat source for generating mechanical and/or electrical power. The low temperature loop Rankine cycle arrangement 146 includes a closed loop fluid path 158 having a fluid pump 160, an expander 162, and a condenser 164 positioned therealong. A quantity of fluid is circulated through closed loop fluid path 158 by way of pump 160. According to one embodiment, fluid can be in the form of water. Alternatively, it is recognized that fluid could be in the form of a refrigerant or an organic fluid having a boiling point lower or higher than water, such that the low temperature loop Rankine cycle arrangement 146 is in the form of an Organic Rankine cycle.

As shown in FIG. 6, pump 160 is positioned upstream of heat exchanger 124 in the closed loop fluid path 158 such that a stream of fluid is provided to heat exchanger 124. Heat exchanger 124 extracts thermal energy from exhaust gas vented from turbine 24 and functions as a heat source for low temperature loop Rankine cycle arrangement 146. Heat exchanger 124 thus heats fluid circulating through closed loop fluid path 158, with either a heated fluid, a 2-phase mixture, or a vapor exiting heat exchanger 124 and being passed along closed loop fluid path 158 for further heating. That is, as shown in FIG. 6, the condenser 154 of the high temperature loop Rankine cycle arrangement 144 acts as an evaporator in the low temperature loop Rankine cycle arrangement 146. Thus, the heated fluid or a vapor passed from heat exchanger 124 and through closed loop fluid path 158 is further heated by condenser/evaporator 154 to form vapor. The vapor generated by condenser/evaporator 154 is passed to expander 162, which is positioned downstream therefrom in the closed loop fluid path 158. Expander 162 functions to expand the vapor, thereby generating mechanical energy that is transferred, for example, to a generator 166 (or a crankshaft) to make use of the mechanical energy. Upon passing through expander 162, vapor passes to a condenser 164 positioned downstream from the expander in the closed loop fluid path 158 such that the vapor is cooled by the condenser 164. The condenser 164 cools the expanded vapor in a controlled manner to transform the vapor back into a liquid fluid, which is then received by pump 160 and recirculated through the closed loop fluid path 158.

The arrangement of first and second waste heat recovery systems in the form of a cascading Rankine cycle arrangement having low and high temperature loops, such as shown in the embodiments of FIGS. 5 and 6, provides a high efficiency engine system 10 that utilizes thermal energy extracted from exhaust gas. That is, by capturing the thermal energy in the exhaust gas both being recirculated to the engine 12 via EGR system 36 and the exhaust gas vented to the ambient environment after passing through exhaust conduit 20 and turbine 24, a maximum amount of thermal energy in exhaust gas emitted by engine 12 can be transformed into mechanical power, so as to improve the efficiency of engine system 10.

It is recognized that in each of the engine systems 10 shown in FIGS. 5 and 6, that the flow direction of fluid through the low and high temperature Rankine cycle arrangements can be reversed. Additionally, it is recognized that in each of the embodiments of FIGS. 5 and 6, that the thermal oil loop 118 could be removed from the waste heat recovery system operating as the high temperature loop of the cascading Rankine cycle arrangement.

In various other embodiments, the system 10 can comprise other components such as additional valves, particulate filters, exhaust treatment devices (e.g., catalytic converters and NOₓ traps), sensors, and the like. The arrangement of these components within the system varies depending on the application and is readily understood by those in the art.

Advantageously, the systems and method disclosed herein function to increase the efficiency of the engine by providing waste heat recovery systems that utilize thermal energy extracted from exhaust gas. By capturing the thermal energy in the exhaust gas, waste heat recovery systems transform waste heat into mechanical or electrical power so as to improve the efficiency of the engine system.

Therefore, according to one embodiment of the invention, an engine system includes an engine having an intake manifold and an exhaust manifold, an exhaust conduit connected to the exhaust manifold to convey an exhaust gas away from the engine, and a turbocharger having a turbine and a compressor driven by the turbine, wherein the turbine is connected to the exhaust conduit to receive a portion of the exhaust gas from the exhaust manifold, and wherein the compressor is positioned upstream of, and connected to, the intake manifold. The engine system also includes an exhaust gas recirculation (EGR) system connected to the exhaust conduit to receive at least a portion of the exhaust gas therefrom, with the EGR system further including an EGR conduit connected to the exhaust conduit to receive the at least a portion of the exhaust gas and having an input and an output, a heat exchanger connected to the EGR conduit between the input and the output and being configured to extract heat from the at least a portion of the exhaust gas, and a waste heat recovery system connected to the heat exchanger and configured to capture the heat extracted by the heat exchanger.

According to another embodiment of the invention, an exhaust gas recirculation (EGR) apparatus includes an EGR circuit having an input configured to receive an exhaust gas from an engine exhaust port, an output configured to return the exhaust gas to an intake port of the engine, and an EGR path configured to circulate the exhaust gas between the input and the output. The EGR apparatus also includes a heat exchanger connected to the EGR circuit in the EGR path between the input and the output and configured to extract thermal energy from the exhaust gas circulating through the EGR path and a waste heat recovery apparatus connected to the heat exchanger and configured to capture the thermal energy extracted by the heat exchanger.

According to yet another embodiment of the invention, a method for capturing waste heat in an engine system includes conveying exhaust gas from an exhaust manifold of an internal combustion engine to an exhaust gas recirculation (EGR) system and circulating the exhaust gas through an EGR conduit of the EGR system. The method also includes extracting heat from the exhaust gas circulating through the EGR conduit by way of a heat exchanger and capturing the heat extracted by the heat exchanger in a waste heat recovery system.

The invention has been described in terms of the preferred embodiment, and it is recognized that equivalents, alternatives, and modifications, aside from those expressly stated, are possible and within the scope of the appending claims.

What is claimed is:

1. An engine system, comprising:
an engine having an intake manifold and an exhaust manifold;
an exhaust conduit connected to the exhaust manifold to convey an exhaust gas away from the engine;
a turbocharger having a turbine and a compressor driven by the turbine, wherein the turbine is connected to the exhaust conduit to receive a portion of the exhaust gas from the exhaust manifold, and wherein the compressor is positioned upstream of, and connected to, the intake manifold; and
an exhaust gas recirculation (EGR) system connected to the exhaust conduit to receive at least a portion of the exhaust gas therefrom, the EGR system comprising:
an EGR conduit connected to the exhaust conduit to receive the at least a portion of the exhaust gas, the EGR conduit having an input and an output;
a heat exchanger connected to the EGR conduit between the input and the output and being configured to extract heat from the at least a portion of the exhaust gas; and
a waste heat recovery system connected to the heat exchanger and configured to capture the heat extracted by the heat exchanger.

2. The engine system of claim 1 wherein the waste heat recovery system comprises:
a water supply;
a water path connecting the water supply to the heat exchanger to provide a flow of water thereto, such that the flow of water is heated by the heat exchanger to generate steam; and
a steam path configured to route the steam from the heat exchanger to at least one of the turbine of the turbocharger and a secondary turbine.

3. The engine system of claim 1 wherein the waste heat recovery system comprises a first Rankine cycle arrangement, the first Rankine cycle arrangement including:
a pump configured to pump a fluid through a closed loop fluid path of the first Rankine cycle arrangement, the pump positioned upstream of the heat exchanger in the closed loop fluid path such that the fluid is provided to the heat exchanger and heated thereby to form a vapor;
an expander positioned downstream from the heat exchanger in the closed loop fluid path to expand the vapor, thereby generating a mechanical power output; and
a condenser positioned downstream from the expander in the closed loop fluid path to receive the expanded vapor and reform a liquid fluid therefrom.

4. The engine system of claim 3 wherein the first Rankine cycle arrangement further comprises a valve positioned in the closed loop fluid path between the heat exchanger and the condenser, the valve configured to vent vapor to a vapor path when the condenser reaches a peak load.

5. The engine system of claim 4 further comprising a fluid tank configured to provide additional fluid to the closed loop fluid path of the first Rankine cycle arrangement when vapor is vented to the vapor path.

6. The engine system of claim 3 wherein the first Rankine cycle arrangement comprises an Organic Rankine cycle arrangement, with the fluid comprising an organic fluid.

7. The engine system of claim 3 further comprising a second heat exchanger connected to an output of the turbine of the turbocharger, wherein the second heat exchanger is connected to the closed loop fluid path of the first Rankine cycle arrangement downstream of the pump such that the fluid is provided to the second heat exchanger and heated thereby.

8. The engine system of claim 3 further comprising a second waste heat recovery system configured to capture heat present in exhaust gas exiting from an output of the turbine of the turbocharger, the second waste heat recovery system including a second Rankine cycle arrangement connected to a second heat exchanger positioned at the output of the turbine and comprising:
a pump configured to pump a fluid through a closed loop fluid path of the second Rankine cycle arrangement;
an expander positioned downstream from the evaporator in the closed loop fluid path to expand the vapor, thereby generating a mechanical power output; and
a condenser positioned downstream from the expander in the closed loop fluid path to receive the expanded vapor and reform a liquid fluid therefrom.

9. The engine system of claim 8 wherein the first Rankine cycle arrangement and the second Rankine cycle arrangement form a cascading Rankine cycle arrangement having a low temperature loop and a high temperature loop.

10. The engine system of claim 9 wherein the first Rankine cycle arrangement comprises the high temperature loop and the second Rankine cycle arrangement comprises the low temperature loop; and
wherein the condenser of the first Rankine cycle arrangement is additionally connected to the closed loop fluid path of the second Rankine cycle arrangement to function as an evaporator in the second Rankine cycle arrangement.

11. The engine system of claim 8 further comprising a thermal oil loop connected to the high temperature loop of the cascading Rankine cycle arrangement, the thermal oil loop comprising:
a closed loop oil path;
a pump to circulate oil through the closed loop oil path; and
an evaporator positioned along the closed loop oil path such that the oil is provided to the evaporator;
wherein the thermal oil loop is connected to the heat exchanger corresponding to one of the high temperature loop of the cascading Rankine cycle arrangement, such that heat extracted from the exhaust gas by the corresponding heat exchanger is transferred to the oil circulating through the closed loop oil path; and
wherein the closed loop fluid path of the high temperature loop is connected to the evaporator of the thermal oil loop such that the fluid flowing through the closed loop fluid path of the high temperature loop is heated by the evaporator of the thermal oil loop.

12. An exhaust gas recirculation (EGR) apparatus, comprising:
an EGR circuit comprising:
an input configured to receive an exhaust gas from an engine exhaust port;
an output configured to return the exhaust gas to an intake port of the engine; and
an EGR path configured to circulate the exhaust gas between the input and the output;
a heat exchanger connected to the EGR circuit in the EGR path between the input and the output, the heat exchanger configured to extract thermal energy from the exhaust gas circulating through the EGR path; and
a waste heat recovery apparatus connected to the heat exchanger and configured to capture the thermal energy extracted by the heat exchanger.

13. The EGR apparatus of claim 12 wherein the waste heat recovery apparatus comprises:
a water supply;
a water path connecting the water supply to the heat exchanger to provide a flow of water thereto, such that the flow of water is heated by the heat exchanger to generate steam; and
a steam path configured to route the steam from the heat exchanger to at least one power generating device.

14. The EGR apparatus of claim 13 wherein the at least one power generating device comprises an expander.

15. The EGR apparatus of claim 12 wherein the waste heat recovery apparatus comprises a Rankine cycle arrangement, the Rankine cycle arrangement including:
a pump configured to pump a fluid through a closed loop fluid path of the Rankine cycle arrangement, the pump positioned upstream of the heat exchanger in the closed loop fluid path such that the fluid is provided to the heat exchanger and heated thereby to form a vapor;
an expander positioned downstream from the heat exchanger in the closed loop fluid path to expand the vapor, thereby generating a mechanical power output; and
a condenser positioned downstream from the expander in the closed loop fluid path to receive the expanded vapor and reform a liquid fluid therefrom.

16. The EGR apparatus of claim 15 wherein the Rankine cycle arrangement further comprises a valve positioned in the closed loop fluid path between the heat exchanger and the condenser, the valve configured to vent vapor to a vapor path when the condenser reaches a peak load.

17. The EGR apparatus of claim 15 further comprising a fluid tank configured to provide additional fluid to the closed loop fluid path of the Rankine cycle arrangement when vapor is vented to the vapor path.

18. The EGR apparatus of claim 15 wherein the Rankine cycle arrangement comprises an Organic Rankine cycle arrangement, with the fluid comprising a refrigerant or an organic fluid.

19. A method for capturing waste heat in an engine system, the method comprising:
conveying exhaust gas from an exhaust manifold of an internal combustion engine to an exhaust gas recirculation (EGR) system;
circulating the exhaust gas through an EGR conduit of the EGR system;
extracting heat from the exhaust gas circulating through the EGR conduit by way of a heat exchanger; and
capturing the heat extracted by the heat exchanger in a waste heat recovery system.

20. The method of claim 19 wherein capturing the heat in a waste heat recovery system comprises:
providing a flow of water through the heat exchanger such that the flow of water is heated by the heat exchanger to generate steam; and
routing the steam generated from the heat exchanger to at least one turbine, thereby generating a mechanical power output from the turbine.

21. The method of claim 19 wherein capturing the heat in a waste heat recovery system comprises utilizing the heat extracted from the exhaust gas by the heat exchanger in a Rankine cycle arrangement to generate a mechanical power output, wherein utilizing the heat extracted from the exhaust gas by the heat exchanger comprises:
pumping a fluid through a closed loop fluid path of the Rankine cycle arrangement;
heating the fluid in the closed loop fluid path using the heat extracted from the exhaust gas by the heat exchanger so as to form a vapor;
expanding the vapor in a turbine positioned downstream from the heat exchanger in the closed loop fluid path to generate the mechanical power output; and
condensing the expanded vapor in a condenser positioned downstream from the turbine in the closed loop fluid path to reform fluid.

22. The method of claim 21 wherein capturing the heat in a waste heat recovery system comprises:
selectively venting vapor out from the closed loop fluid path of the Rankine cycle arrangement; and
routing the vented vapor to at least one turbine, thereby generating a mechanical power output from the turbine.

23. The method of claim 19 further comprising:
conveying exhaust gas from the exhaust manifold of the internal combustion engine to a turbocharger in the engine system, the turbocharger including a turbine, a compressor, and a drive shaft connecting the turbine to the compressor;
extracting heat from the exhaust gas upon passing through the turbine by way of a heat exchanger; and
capturing the heat extracted by the heat exchanger in a secondary waste heat recovery system, the secondary waste heat recovery system comprising a thermal oil loop and a Rankine cycle arrangement.
